(19) United States
(12) Patent Application Publication
(10) Pub. No.: US 2004/0005468 A1
(43) Pub. Date: Jan. 8, 2004

(54) Method of providing a metallic contact on a silicon solar cell

(76) Inventor: Carl P. Steinecker, South Lyon, MI (US)

Correspondence Address: John L. Cordani, Carmody & Torrance LLP, 50 Leavenworth Street, P.O. Box 1110, Waterbury, CT, 06721-1110, US

(21) Appl. No.: 10/189,948

(22) Filed: Jul. 3, 2002

(51) Int. Cl. B05D 3/10; B05D 1/18; B32B 9/06

(52) U.S. Cl. 428/446; 427/304; 427/438; 428/450

(57) ABSTRACT

An improved process for producing a more uniform deposition of the nickel on the surface of a silicon solar cell comprising the steps of immersing the silicon solar cell into an activator solution comprising gold and a fluoride salt, and subsequently immersing the solar cell into an electroless nickel plating solution. The process provides an improved deposition of nickel on the silicon solar cell, and produces a more uniform deposition of nickel as compared to the prior art. Subsequent to the nickel deposition step, the solar cell may be sintered to produce a nickel silicide layer.

### FIELD OF THE INVENTION

The present invention relates to an improved method of providing a metallic contact on a silicon surface, such as a silicon solar cell. The method comprises immersing the silicon surface in an activator solution comprising gold followed by plating in a nickel plating solution.

### BACKGROUND OF THE INVENTION

It is often desirable in the manufacture of solar cells and other semiconductor devices, to plate nickel directly onto silicon so as to form electrodes or contacts for coupling the semiconductor device into an electric circuit. One of the most well-known and effective ways of achieving such plating is though electroless nickel plating.

In such an electroless nickel plating process, the first step generally consists of cleaning the outer surfaces of the silicon substrate where the nickel is to be deposited so as to remove any particles of dirt or oxide, which may be present. The cleaning may be accomplished in various ways that are well known to those skilled in the art. For example, the silicon surface may be cleaned and deoxidized with a dilute hydrofluoric acid solution and then rinsed.

Once the silicon surface, which is to receive the nickel, has been cleaned, the silicon is ready for electroless nickel plating. Plating is accomplished by immersing the silicon substrate in a suitable acidic or alkaline bath under suitable plating conditions. Typical plating baths comprise an aqueous solution of a water soluble salt of the metal to be deposited, a reducing agent for the metal cations, and a complexing agent for the metal cations. A stabilizer, such as lead, may also be added to the solution. U.S. Pat. No. 4,321,283, to Patel et al., the subject matter of which is herein incorporated by reference in its entirety, discloses various methods of plating nickel onto silicon. U.S. Pat. No. 3,403,035 to Schneble, Jr., the subject matter of which is herein incorporated by reference in its entirety, discloses a process for stabilizing electroless metal plating solutions and discloses various electroless metal plating solutions.

The function of the complexing agent is to form a water-soluble complex with the dissolved metallic cations so as to maintain the metal in solution. The complexing agent is selected so that it forms a strong complex with the metal ions to prevent the precipitation of metal or metallic salts. Complexing agents include, for example, ammonia, citric acid, and tartaric acid. Other complexing agents are also well known in the prior art.

The function of the reducing agent is to reduce the metal cation to metal. Reducing agents that are typically used in electroless metal plating solutions include borohydrides, amine boranes, hydrazines, hypophosphites, hydrosulfites, hydroxyl amines, formaldehyde and the like.

For proper operation, the pH of the solution will be controlled, and will depend on the nature of the metal salt, the complexing agent, and the reducing agent. Depending on the ingredients, the solution may range from strongly acid to strongly alkaline. Silicon semiconductors are usually doped with elements like boron or phosphorus to form negative or positive domains. Phosphorus doping causes the silicon to be more easily attacked by the plating solution such that alkaline electroless nickel solutions will preferentially form heavier immersion nickel coatings where the silicon is more heavily doped.

One example of a prior art plating bath is an alkaline ammoniated electroless nickel bath. Immersion of the wafer into the solution causes a displacement nickel deposit to form. However, initiation of the nickel is often not uniform, resulting in poor coverage and poor adhesion on the silicon substrate. If the nickel deposit is too thick, adhesion is also generally poor. In addition, if the phosphorus doping of the silicon is not uniform or is absent, the nickel deposit does not adhere, resulting in little or no plating in that area. Thus, in this process, the silicon cells may need to be stripped and replated several times, and even scrapped if they are processed too many times.

While the most common method of plating nickel onto a silicon solar cell is to initiate plating onto a silicon substrate by forming a nickel deposit by electroless plating using an alkaline nickel bath, several prior art processes use a catalyst for pretreating the surface of the silicon substrate prior to plating. This catalyst pretreatment may be used in plating silicon for solar cells and other semiconductor applications. Non-metallic surfaces, such as silicon, are generally non-catalytic, and nickel plated on an untreated silicon surface tends to adhere poorly. The surface can be rendered catalytic by producing a film of particles of one of the catalytic materials on the surface. Such processes are generally well known in the art. One such process involves contacting the surface with an acidic solution of a precious metal salt such as palladium, although other activators are also known to those skilled in the art.

Where it is desired that the deposited nickel serve as an ohmic contact, the nickel layer is sintered so as to diffuse into the silicon substrate and form a nickel silicide at the nickel/silicon interface. The silicon solar cell or silicon wafer is sintered in a reducing furnace at approximately 400° C. for 10 minutes to form the nickel silicide layer. The silicon solar cell may then be further coated with nickel, copper and silver to produce a functional solar cell.

While the technology of electroless metal, and particularly electroless nickel, plating baths is generally well known, there is still a need to improve the process to produce a more uniform deposition of the nickel on the surface of the silicon. The process of the instant invention provides an improved deposition of nickel on a silicon surface, such as a silicon solar cell. The process of the instant invention solves many of the problems of the current technology by using an activator solution that comprises gold, followed by an electroless nickel plating process to obtain the initial layer of nickel on the silicon solar cell. The solar cell may then be sintered to produce a nickel silicide layer.

Electroless nickel plating processes of the prior art may contain a high concentration of volatile ammonia that evaporates, needing constant replenishment. The pH of the solution is thereby difficult to control and the ammonium ion is difficult to waste treat. The process of the instant invention does not contain ammonia, but instead uses an alkali metal hydroxide to control the pH of the nickel plating solution. The use of the alkali metal hydroxide produces a more stable pH than the ammonia of the prior art.

Another problem with the electroless nickel plating baths of the prior art is that the nickel deposit has a high tensile internal stress so that the thickness plated is extremely critical. If the thickness is only slightly too thick, then the nickel deposit will not adhere satisfactory and will blister and peel. A high thickness will also cause an electrical short through the phosphorus-doped silicon layer when the cell is sintered. The plating rate of the current technology may be too fast, thus necessitating very short plating times, and making it very difficult to control the thickness of the nickel deposit. Furthermore, even if a catalyst, such as palladium, is used, a non-uniform initiation on the silicon cell may be produced, such that nickel plating may occur on areas of the cell where plating is not desired, for example, the solar collection areas of the cell.

In contrast, the electroless nickel process of the instant invention uses a gold catalytic activator to produce uniform initiation on the silicon with a resulting uniform deposit thickness over the surface of the silicon solar cell. The process produces a deposit with a low internal stress and perfect adhesion over the entire exposed silicon surface only where it is desired. The nickel is deposited in a slow, controlled manner so that consistent nickel thicknesses are obtained. Unlike palladium activators of the prior art, the gold activators used in the present invention are less expensive than palladium, remain stable in solution, and do not cause instability in the nickel plating bath or cause plateout onto the plastic cell caddies used to hold the silicon solar cells during processing or the anti-reflective coating on the sun exposure side of the cell.

In addition, the high concentration of lead in the nickel plating solutions of the prior art produces a deposit with a high lead content. After sintering, the surface film resulting from the lead is very resistant to reactivation which is necessary for further processing. In addition, lead is a highly toxic material, and, in spite of its high concentration, the plating solution has a tendency to be unstable and plate on the sides and bottom of the tank.

In contrast, the process of the instant invention does not contain any metallic stabilizer, so that the sintered layer is more easily activated for further processing. Consequently, there is less dependence on a bath loading effect (cell surface area to solution volume ratio). As compared to the prior art processes, the process of the present invention has demonstrated perfect solution stability under laboratory test conditions. This improved process reduces operating costs by eliminating stripping and replating steps in the process and by reducing costs associated with waste treatment and exhaust scrubber operation.

### SUMMARY OF THE INVENTION

It is a primary object of the present invention to develop an improved method of making a metallic contact on a silicon surface, such as a silicon solar cell.

It is another object of the present invention to develop a method of making a metallic contact on a silicon solar cell using an electroless nickel plating process that is more stable than prior art plating processes.

The objects of the present invention can be accomplished by a method of making metallic contacts on silicon solar cells comprising the steps of:

(a) immersing a silicon solar cell into an activator solution comprising gold; and

(b) subsequently, immersing the silicon solar cell into a nickel plating solution for a period of time to produce the desired plating thickness.

### DETAILED DESCRIPTION OF THE INVENTION

Preferred embodiments of a method of providing a metallic contact on a silicon solar cell according to the present invention are described in detail below.

The process of the present invention comprises treating a silicon surface, such as a silicon solar cell, with an activator solution and then treating the activated silicon surface with an electroless nickel plating solution. The silicon solar cell may be partially coated with aluminum. Processes for coating the solar cell with aluminum are generally well known in the art, and include, for example, vacuum deposition, sputtering. The aluminum is then typically sintered into the silicon surface and passivated with oxygen. Other techniques may also be used.

The partially aluminum-coated solar cell is cleaned and/or deoxidized in a dilute hydrofluoric acid solution, as is done in the prior art. If desired, the solar cell is then rinsed. The cell is activated by being immersed in an activator solution comprising gold, preferably a dilute solution of ammonium bifluoride and a soluble salt of gold, preferably gold trichloride. The solar cell is rinsed again, and then plated in an electroless nickel plating solution to obtain the initial layer of nickel prior to sintering.

The gold activator solution preferably comprises ammonium bifluoride and gold (trivalent as chloride). The ammonium bifluoride is preferably present in the solution at a concentration of about 10 to 15 g/l, most preferably about 12 g/l of ammonium bifluoride. Lower amounts of ammonium bifluoride do not keep the gold adequately soluble and produce non-uniform activation. Higher amounts of ammonium bifluoride can cause excessive etching of the aluminum coating.

The gold is generally present in the activator solution at a concentration of about 5 to 50 mg/l, preferably about 20 mg/l. Lower amounts of gold do not activate the silicon surface uniformly, while higher amounts are wasteful of the gold and may cause reduced nickel adhesion on the silicon surface.

The temperature of the activator solution is generally between about 15 and 30° C., preferably about 22° C. The silicon surface is immersed in the activator solution for a period of time, generally ranging from about 30 seconds to about 3 minutes, preferably about 2 minutes. The activator solution may be subject to agitation to produce a slight solution movement.

The nickel plating solution generally comprises:

(1) a soluble nickel salt;

(2) a complexor for the nickel ions;

(3) sodium hypophosphite; and

(4) an alkanolamine.

The soluble nickel salt is preferably nickel sulfamate, which is generally present at a concentration of about 0.05 to 0.15 molar, preferably about 0.1 molar.

Preferred complexors for the plating solution include citrates, such as citric acid, and pyrophosphates. The complexor is generally present at a concentration of about 0.1 to 0.25 molar, preferably about 0.15 molar.

The concentration of the sodium hypophosphite in the plating solution is generally about 0.15 to 0.35 molar, preferably about 0.25 molar.

Preferred alkanolamines include tris(hydroxymethyl)amino methane and 2-amino-1-butanol. The alkanolamine is preferably a primary amine, and most preferably has some complexing ability. The concentration of the alkanolamine is generally about 0.05 to 0.25 molar, preferably about 0.1 molar.

The nickel plating bath has a pH in the range of about 9.5 to 11.0, preferably about 10.5. The pH of the plating bath is preferably controlled by the use of an alkali metal hydroxide. Potassium hydroxide and sodium hydroxide are examples of suitable alkali metal hydroxides that may be used in the present invention. Ammonium hydroxide may also be used but is not preferred.

The temperature of the plating bath is generally about 50 to 75° C., preferably about 65° C. The silicon solar cell is immersed in the plating bath until the desired thickness of nickel is achieved, which is typically 120 nm. This generally takes about 5 minutes. If desired, the nickel plating solution may be subjected to slight agitation to produce a mild solution movement.

The nickel plating bath is also controlled so as to have a dissolved oxygen level of less than about 4 mg/l.

The invention is further described by reference to the following non-limiting examples.

### EXAMPLE 1

A silicon solar cell with a phosphorus-doped outer layer, and aluminum sputtered on the back, was immersed in a dilute hydrofluoric acid solution, comprising 4% by weight of hydrofluoric acid for one minute at a temperature of 30° C., and was then rinsed with deionized water.

The silicon solar cell was immersed in a gold activator solution comprising 12 g/l ammonium bifluoride and 20 mg/l of gold (as gold trichloride). The solar cell was immersed in the activator solution for two minutes at a temperature of 20° C.

The solar cell was then rinsed with deionized water for one minute and immersed in a nickel plating solution comprised of:

0.1 molar nickel sulfamate

0.15 molar tetrapotassium pyrophosphate

0.135 molar 2-amino-1-butanol

0.26 molar sodium hypophosphite

The pH of the plating solution was adjusted to 10.2 with a potassium hydroxide solution, and the plating solution was maintained at a temperature of 60° C.

The plating solution was dummied with a nickel panel to reduce the dissolved oxygen of the solution to less than about 4 mg/l prior to plating the silicon solar cell.

The silicon solar cell was initiated within 20 seconds and then plated for 5 minutes to produce a deposit on the exposed silicon of 114 nm. The deposit exhibited perfect adhesion when tested with adhesive tape.

A second cell was plated in a similar manner, but was plated for 10 minutes to a thickness, as measured by XRF, of 254 nm. Again, there were no observed blisters. The deposit was uniform in thickness and no loss of adhesion was found with a tape adhesion test.

### EXAMPLE 2

Another cell was prepared in a like manner to Example 1, but was treated with a nickel plating solution comprised of:

0.1 molar nickel sulfamate

0.125 molar citric acid

0.066 molar tris(hydroxymethyl)aminomethane

0.26 molar sodium hypophosphite

The cell was initiated within 30 seconds and the deposit was uniform and adherent after plating to a thickness of 440 nm. The silicon solar cell demonstrated superior adhesion and low stress, even at heavier thicknesses. No nickel was observed to be plated onto the bottom or sides of the beaker.

### COMPARATIVE EXAMPLE 3

The silicon solar cell was prepared in a like manner to Example 1, but was treated with a nickel plating solution comprised of:

0.1 molar nickel sulfamate

0.26 molar citric acid

0.26 molar sodium hypophosphite

The pH of the plating solution was adjusted to 10.0 with a potassium hydroxide solution. The plating solution was maintained at a temperature of 65° C. and was dummied with a nickel panel to reduce the dissolved oxygen to less than about 4 mg/l.

The cell was cleaned and deoxidized in the hydrofluoric acid solution of Example 1, rinsed, and then immersed into the nickel plating solution. Initiation was very slow and after 5 minutes, there was only a powdery non-adherent deposit.

Another cell was processed through the hydrofluoric acid solution and the gold activator solution of Example 1 before being immersed in the nickel plating solution. However, only 86 nm of nickel was deposited after 5 minutes. The adhesion was improved such that the adhesive tape did not remove the deposit. After running only two cells, the solution spontaneously plated out.

### COMPARATIVE EXAMPLE 4

A silicon solar cell was prepared in a like manner to Example 1, but without the gold and was treated with a nickel plating solution comprised of:

0.1 molar nickel sulfamate

0.15 molar tetrapotassium pyrophosphate

0.28 molar sodium hypophosphite

The pH of the plating solution was adjusted to 10.4 with ammonium hydroxide. The plating solution was maintained at a temperature of 50° C. The plating solution was dummied with a nickel panel to reduce the dissolved oxygen of the solution to less than about 4 mg/l.

A silicon solar cell was immersed in the hydrofluoric acid solution of Example 1 for 2 minutes, rinsed, and then immersed in the above plating solution. Plating initiated after 35 seconds, and was observed to start at the edges of the cell and spread inward. After one minute, blisters started to form at the edges of the cell due to the greater amount of phosphorus doping, while coverage of the center area was incomplete. After 2 minutes, the cell was removed from the plating solution.

Rinsing with water resulted in the removal of much of the deposit. Where the deposit was adherent, the thickness was measured to range from 70 to 200 nm.

What is claimed is:

1. A method of making a metallic contact on a silicon surface comprising the steps of:
(1) immersing said silicon surface into an activator solution comprising gold; and
(2) subsequently immersing said silicon surface into an electroless nickel plating solution for a period of time to produce a desired plating thickness.

2. The method according to claim 1, wherein the activator solution comprises ammonium bifluoride and gold trichloride.

3. The method according to claim 2, wherein the activator solution comprises about 10-15 g/l of ammonium bifluoride.

4. The method according to claim 3, wherein the activator solution comprises about 12 g/l of ammonium bifluoride.

5. The method according to claim 2, wherein the activator solution comprises about 5-30 mg/l of gold as trichloride.

6. The method according to claim 5, wherein the activator solution comprises about 20 mg/l of gold as trichloride.

7. The method according to claim 1, wherein the activator solution has a temperature of between 15 and 30° C.

8. The method according to claim 7, wherein the temperature of the activation solution is about 22° C.

9. The method according to claim 1, wherein the electroless nickel plating solution comprises:
a) a soluble nickel salt;
b) a complexor;
c) sodium hypophosphite; and
d) an alkanolamine.

10. The method according to claim 9, wherein the nickel salt is nickel sulfamate having a concentration of about 0.05 to 0.15 molar.

11. The method according to claim 9, wherein the complexor is selected from the group consisting of citrates and pyrophosphate.

12. The method according to claim 9, wherein the concentration of the complexor is from 0.1 to 0.25 molar.

13. The method according to claim 9, wherein the concentration of the sodium hypophosphite is 0.15 to 0.35 molar.

14. The method according to claim 9, wherein the alkanolamine is selected from the group consisting of tris (hydroxymethyl) aminomethane and 2-amino-1-butanol.

15. The method according to claim 14, wherein the concentration of the alkanolamine is from 0.05 to 0.25 molar.

16. The method according to claim 1, wherein the plating solution has a pH between 9.5 and 11.0.

17. The method according to claim 16, wherein the plating solution has a pH of 10.5.

18. The method according to claim 16, wherein the pH of the plating solution is controlled using an alkali metal hydroxide.

19. The method according to claim 1, wherein the plating solution has a dissolved oxygen level of less than about 4 mg/l.

20. The method according to claim 1, wherein the silicon surface is sintered to form a nickel silicide layer.

21. A silicon solar cell having a metallic contact situated thereon, wherein said metallic contact is formed by activating said silicon solar cell with an activator solution comprising gold and subsequently plating with an electroless nickel plating solution.

22. The silicon solar cell of claim 21, wherein said activator solution comprises:
a) about 10 to 15 g/l of ammonium bifluoride; and
b) about 5 to 50 mg/l of gold as trichloride.

23. The silicon solar cell of claim 22, wherein said plating solution comprises:
a) a soluble nickel salt;
b) a complexor selected from the group consisting of citrates and pyrophosphates;
c) sodium hypophosphite; and
d) an alkanolamine.

24. The silicon solar cell of claim 23, wherein said alkanolamine is selected from the group consisting of tris (hydroxymethyl) aminomethane and 2-amino-1-butanol.

25. The silicon solar cell of claim 21, wherein the plating solution has a pH between 9.5 and 11, and the plating solution is maintained at a temperature of 50 to 75° C.

26. The silicon solar cell of claim 25, wherein the pH of the plating solution is controlled using an alkali metal hydroxide.
